(19) United States
(12) Patent Application Publication
(10) Pub. No.: US 2008/0062722 A1
(43) Pub. Date: Mar. 13, 2008

(54) Backlight module and flat panel display

(75) Inventors: Yao-Tung Wang, Padeh City (TW); Kuo-Tung Liao, Padeh City (TW)

Correspondence Address: BIRCH STEWART KOLASCH & BIRCH, PO BOX 747, FALLS CHURCH, VA, 22040-0747, US

(73) Assignee: CHUNGHWA PICTURE TUBES, LTD

(21) Appl. No.: 11/785,015

(22) Filed: Apr. 13, 2007

(30) Foreign Application Priority Data
Sep. 8, 2006 (TW) 95133197

(51) Int. Cl. G02F 1/1333

(52) U.S. Cl. 362/633

(57) ABSTRACT

The backlight module in the flat panel display (FPD) includes a frame that resides between the backlight module and the cover of FPD display, and has an inclined plane with an angle between the optical film. The inclined plane causes the touching area broader than the parallel plane does, thus it will absorb more stress force and avoid displaying defects in the FPD panel. Using this structure, the pressure transformed from the FPD cover stresses the inclined plane and forces it to contact the FPD's back light module on broader area in reducing the pressure per unit's area.

### BACKGROUND OF THE INVENTION

1. Field of the Invention

The present invention relates to a backlight module and a flat panel display (FPD), and more especially a backlight module and a flat panel display having a supporting rack for stress dispersion.

2. Background of the Related Art

Generally, in designing the structure of liquid crystal display (LCD), the cover is installed in order to support the whole structure of the back light module in the LCD panel. A frame is disposed between the backlight module and the cover to support the assembly of LCD panel in an integrity way.

In above structure, if imposing pressure on the cover of LCD, the cover will deform in responding to that pressure, and it will continuously bend closely toward the backlight module of the LCD. Consequently, the pressure will be transferred to the back of the backlight module. The FIG. 1 shows a cross-sectional view of frame with the parts of LCD panel. When imposing pressure F on a cover 15, it causes strong stress on a frame 14, and then this stress is transferred through a reflector 13, light guide plate 12 and optical film 11 in the backlight module of the LCD to the panel module 10. Because the frame 14 sticks on the reflector 13, the frame 14 bears the pressure F applies to the frame 14 with small area relative to the cover 15, which makes the LCD producing the black gap or other defect when LCD displaying images. Sometimes, it may seriously cause glasses break in liquid crystal panel module.

### SUMMARY OF THE INVENTION

In order to solve the problems mentioned above, the present invention provides a backlight module with a frame. The frame has the structure of a supporting rack, which has an angle between the optical film, to support the stress force from the cover. The supporting rack causes the broader touching area to bear the intensive stress force and reduce poor displaying phenomenon.

In order to solve the problem that breaking the FPD's components due to the strength caused by external force on the cover, a flat panel display is provided with a frame as a stress buffer structure. The frame tightly stuck on the back of display panel may absorb the stress force from the cover of FPD.

Accordingly, one embodiment of the present invention provides a backlight module including an optical film and a frame with at least one supporting rack, wherein the supporting rack has an angle between the optical film. The flat panel display includes a panel's cover, a backlight module and a panel module disposed on the backlight module.

To enable the objectives, technical contents, characteristics, and accomplishments of the present invention, the embodiments of the present invention are to be described below in detail in cooperation with the attached drawings.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is the cross-sectional view of frame with the parts of LCD panel;

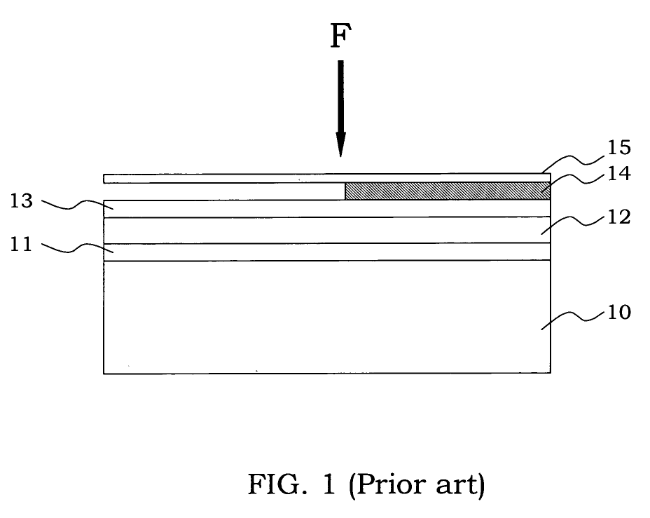

FIG. 2 is the structure of the FPD in accordance with an embodiment of the present invention;

FIG. 3 is the structure of the backlight module in accordance with the FIG. 2;

FIG. 4 is the top view of FIG. 3;

FIG. 5A is the cross sectional view of the AA′ line of FIG. 4; and

FIG. 5B shows the supporting rack bearing the stress force and the whole inclined plane contacting to the optical film in accordance with an embodiment of the present invention.

### DETAILED DESCRIPTION OF THE INVENTION

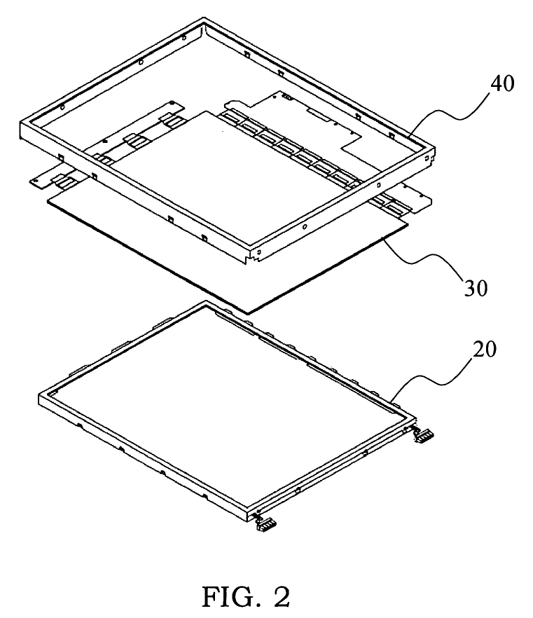

FIG. 2 is the structure of the FPD in accordance with an embodiment of the present invention. For an FPD, a backlight module 20 provides the FPD with light source needed. A panel module 30 processes the light source to display various images. A fixing frame 40 combines backlight module 20 and panel module 30 and holds them together.

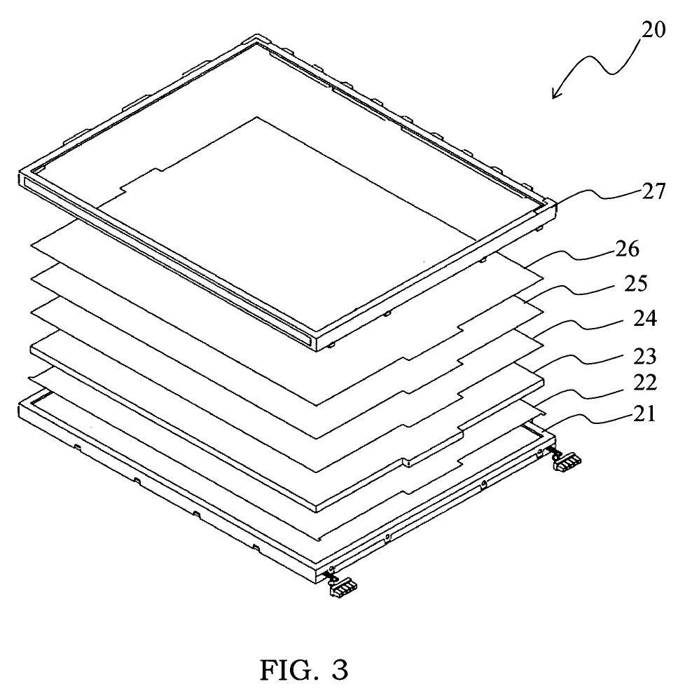

FIG. 3 is the structure of the backlight module in accordance with the FIG. 2. A light source 21 is positioned at the bottom of the backlight module 20 and a light guide plate 23 is placed on the light source 21. A frame 27 may fix whole assembly of the backlight module 20, wherein an optical film 22 is below the light guide plate 23 and a plurality of optical films 24, 25, and 26 are on the upside of light guide plate 23.

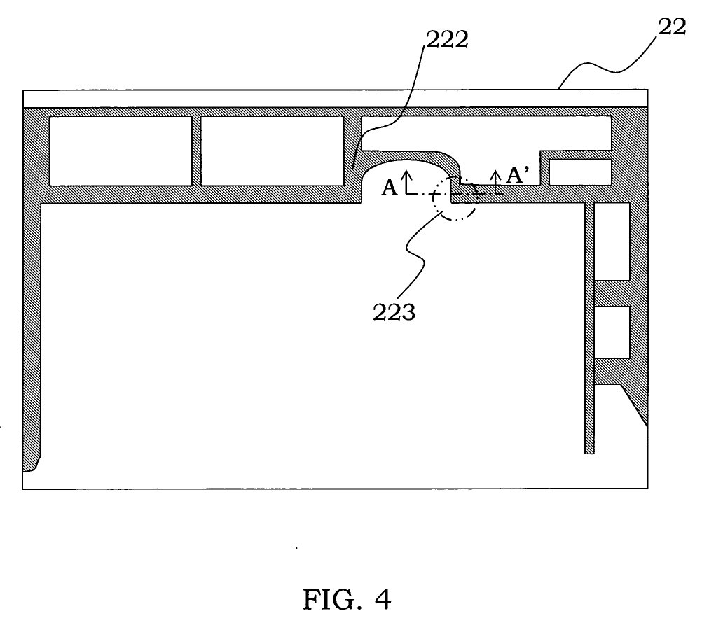

FIG. 4 is a bottom view of FIG. 3. A frame 222 with geometric pattern is placed on the back of optical film 22, and another side of the frame 222 is toward the inside of the FPD's cover (not shown).

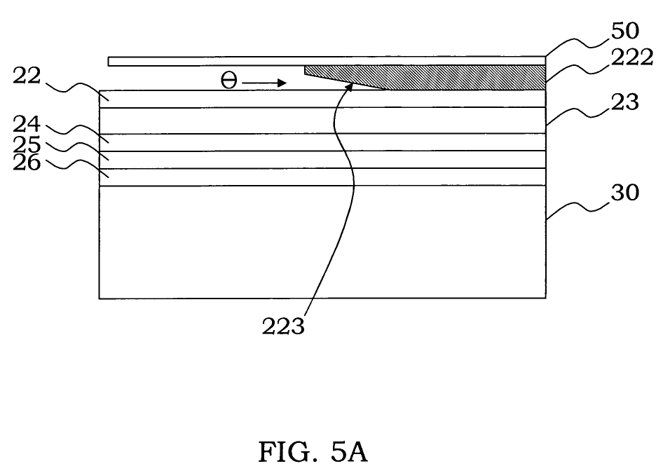

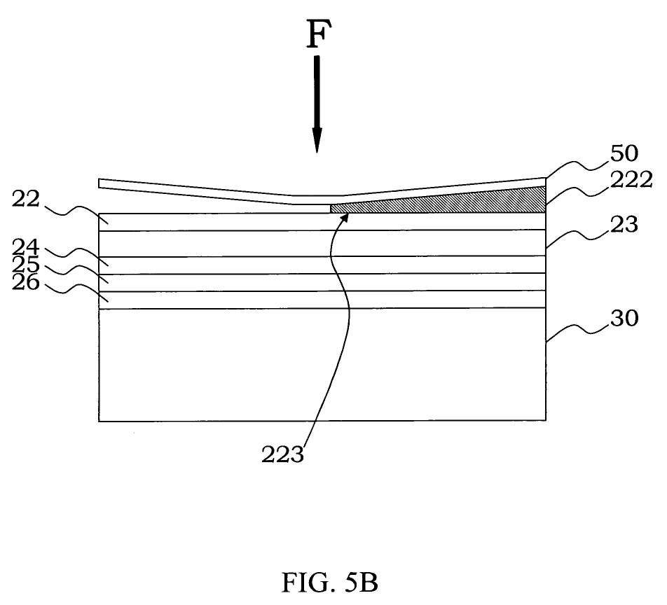

FIG. 5A is a cross sectional view of the A-A′ line of FIG. 4 illustrating a supporting rack 223 in accordance with one embodiment of the present invention. The inside of the FPD's cover 50 contacts with the supporting rack 223, which is a portion of the frame 222 with geometrical pattern. The supporting rack 223 has an inclined plane and contacts with the optical film 22 with an angle θ that makes a space between the supporting rack 223 and the optical film 22, wherein the angle θ is from about 1 degree to about 45 degree. In addition, the other side of optical film 22 is disposed with the light guide plate 23, optical films 24, 25 and 26, wherein the optical film 22 is a reflector. And the panel module 30 contacts with the optical film 26.

According to the structure mentioned above, while exerting a stress force F from the cover 50 of the LCD panel, the stress force conveys to the supporting rack 223, as FIG. 5B shows that the supporting rack 223 will bear the stress force F and the whole inclined plane contacts to the optical film 22. Because the contacted area increases, the pressure per unit area decreases. The supporting rack 223 with angle θ offers better supporting strength in order to bear more stress force and prevent the displaying quality of the FPD from black gap or some defects.

Furthermore, the supporting rack 223 is a portion of frame and made of elastic material, plastic, glue or engineering polymers, such as PC (Polycarbonate), PC+GF (Glass Fiber), PC+ABS (Acrylonitrile-Butadiene-Styrene copolymer). Utilizing this structure of supporting rack 223 to buffer the stress between the back light module and the FPD cover and may absorb the external force transferred from outside of the FPD cover. The invention makes whole FPD firmer than conventional way and prevents it from damage.

In addition, the FPD has a back light module with the light source that could be some cold-cathode fluorescent lamps (CCFL) or some light emitting diodes (LED). Besides, other FPD's applications, such as Plasma Display Panel (PDP), may use the present invention to protect the display panel in same fashion.

Accordingly, the present invention provides a frame structure for stress dispersion in the FPD having a supporting rack that has a tangent plane with an oblique angle. When the external force increases, the supporting rack deforms the tangent plane to contact to the back light module and to increase contact area. Under this situation, the angle is getting smaller accordingly.

Although the present invention has been explained in relation to its preferred embodiment, it is to be understood that other modifications and variation can be made without departing the spirit and scope of the invention as hereafter claimed.

What is claimed is:

1. A backlight module comprising:
a first optical film; and
a frame having at least one supporting rack, wherein said supporting rack has an angle between said first optical film.

2. The backlight module according to claim 1, further comprising a light guide plate disposed on said first optical film and a second optical film disposed on said light guide plate.

3. The backlight module according to claim 1, wherein said first optical film comprises a reflector.

4. The backlight module according to claim 1, wherein said frame comprises a plastic frame.

5. The backlight module according to claim 1, wherein said angle is from about 1 degree to about 45 degree.

6. The backlight module according to claim 1, wherein said supporting rack is composed of elastic material.

7. The backlight module according to claim 6, wherein said elastic material is engineering polymer.

8. A flat panel display (FPD) comprising:
a cover of an FPD;
a backlight module disposed on the inside of said cover of the FPD, said backlight module comprising:
a first optical film; and
a frame having at least one supporting rack, wherein said supporting rack has an angle between said first optical film; and
a panel module disposed on said backlight module.

9. The flat panel display according to claim 8, further comprising a light guide plate disposed on said first optical film and a second optical film disposed on said light guide plate.

10. The flat panel display according to claim 8, wherein said first optical film comprises a reflector.

11. The flat panel display according to claim 8, wherein said frame comprises a plastic frame.

12. The flat panel display according to claim 8, wherein said angle is from about 1 degree to about 45 degree.

13. The flat panel display according to claim 8, wherein said supporting rack is composed of elastic material.

14. The flat panel display according to claim 13, wherein said elastic material is engineering polymer.
